(19) United States
(12) Patent Application Publication
(10) Pub. No.: US 2024/0118120 A1
(43) Pub. Date: Apr. 11, 2024

(54) Monitoring and optimisation of gas consumption

(71) Applicant: SAGEMCOM ENERGY & TELECOM SAS, RUEIL MALMAISON (FR)

(72) Inventor: Henri TEBOULLE, RUEIL MALMAISON (FR)

(21) Appl. No.: 18/472,651

(22) Filed: Sep. 22, 2023

(30) Foreign Application Priority Data
Sep. 29, 2022 (FR) FR2209902

(51) Int. Cl. G01F 15/06; G01F 15/00; G01F 15/02

(52) U.S. Cl. CPC G01F 15/068; G01F 15/005; G01F 15/022

(57) ABSTRACT

A gas meter includes a valve, or means for communicating with a valve, and a processing unit arranged for: analyzing the measurements of the gas consumption to produce predefined parameter measurements relating to the gas consumption, and detecting, from said predefined parameter measurements, one or more operating phases of at least one predetermined system of the installation; for each predetermined system, following each operating phase of said predetermined system, if a cumulated gas consumption during the current period of said predetermined system exceeds a predetermined threshold associated with said predetermined system, closing the valve until the end of said current period.

### DESCRIPTION

The invention relates to the field of so-called “smart” gas meters.

### BACKGROUND OF THE INVENTION

A gas meter very conventionally comprises an internal conduit wherein the gas supplied to an installation circulates through a distribution network, and a measuring device which measures the gas consumption of said installation.

The measuring device is, for example, an ultrasonic measuring device comprising an upstream transducer (network side) and a downstream transducer (installation side). Each transducer acts in succession as an emitter and as a receiver of ultrasonic signals. The upstream transducer thus emits an ultrasonic signal in the internal conduit, which is received by the downstream transducer after having travelled a predefined path (of fully controlled length) in the gas. Then, the downstream transducer itself emits an ultrasonic signal, which is received by the upstream transducer after having travelled the predefined path (in the other direction) in the gas. The ultrasonic measuring device thus evaluates the gas flow from the flight times of the ultrasonic signals between the transducers. The estimation of the gas flow makes it possible to evaluate and to bill for the gas volume consumed.

Certain so-called “smart” modern gas meters, must be capable of cutting off the gas flow.

In certain countries, when an end user (i.e. a subscriber) does not pay their gas bills, the distributor cuts off the gas until the end of the day, as soon as the consumption of the installation exceeds a certain daily threshold.

The cutting off of the gas is conventionally done by controlling a motorised valve which is integrated in a cutoff box located close to the meter, even which is integrated in the meter.

It is considered to use such smart gas meters to assist the user in limiting its gas consumption. Such a functionality has an undeniable interest regarding ecology, but is also very advantageous for the buying power of the user.

### AIM OF THE INVENTION

The invention aims to control and to optimise the gas consumption of an installation, in order, in particular, to reduce the gas bill.

### SUMMARY OF THE INVENTION

In view of achieving this aim, a gas meter is proposed, comprising:
a measuring device arranged to produce measurements of a gas consumption of an installation;
a valve, or communication means with a cutoff box located outside of the meter and integrating a valve;
a processing unit arranged to, each current day, during each current period of a predetermined set of at least one successive period defined in the current day:
   analysing the measurements of the gas consumption to produce predefined parameter measurements relating to gas consumption, and detecting, from said predefined parameter measurements, one or more operating phases of at least one predetermined system of the installation;
   for each predetermined system, following each operating phase of said predetermined system, if a cumulated gas consumption during the current period of said predetermined system exceeds a predetermined threshold associated with said predetermined system, closing the valve until the end of said current period.

Each current day is therefore divided into one or more successive periods.

During each current period, the gas meter detects in the measurements of the gas consumption, one or more signatures, each representative of the operation of a predetermined system (for example, a boiler, a water heater), then cuts off the gas until the end of the current period when the cumulated gas consumption over the current period by one same system exceeds a predetermined threshold. The gas is therefore only cut off in specific cases of use, with the aim of not penalising the user, but rather assisting them in limiting their gas consumption.

In addition, a gas meter is proposed, such as described above, wherein the predefined parameters comprise a gas draw duration and/or an average gas flow and/or a volume of gas consumed.

In addition, a gas meter is proposed, such as described above, wherein, for at least one of the at least one predetermined system, the predetermined threshold associated with said predetermined system depends on said current period and/or current day and/or period of the year to which the current day belongs.

In addition, a gas meter is proposed, such as described above, the gas meter comprising a temperature sensor or being connected to a piece of equipment integrating a temperature sensor, the gas meter being such that, for at least one of the at least one predetermined system, the predetermined threshold associated with said predetermined system depends on a temperature measured by the temperature sensor.

In addition, a gas meter is proposed, such as described above, wherein said predetermined threshold is:
equal to the first value when said temperature is less than a first threshold;
equal to a second value when said temperature is greater than a second threshold;
equal to a linear function of said temperature when said temperature is comprised between the first threshold and the second threshold.

In addition, a gas meter is proposed, such as described above, wherein, for at least one of the at least one predetermined system, the processing unit is arranged, to detect the operating phases of said predetermined system, to compare the predefined parameter measurements with predefined levels which depend on the period of the year to which the current day belongs.

In addition, a gas meter is proposed, such as described above, the gas meter comprising a temperature sensor or being connected to a piece of equipment integrating a temperature sensor, the gas meter being such that, for at least one of the at least one predetermined system, the processing unit is arranged, to detect the operating phases of said predetermined system, to compare the measurements of the predefined parameters with predefined levels which depend on a temperature measured by the temperature sensor.

In addition, a gas meter is proposed, such as described above, wherein the predetermined set of at least one successive period comprises at least one period during which the closing of the valve is prohibited.

In addition, a gas meter is proposed, such as described above, wherein the at least one predetermined system comprises a boiler and a water heater.

In addition, a gas meter is proposed, such as described above, wherein the valve is a ball valve.

In addition, a monitoring method is proposed, implemented in the processing unit of a gas meter, such as described above, and comprising the steps, each current day, during each current period of a predetermined set of at least one successive period defined in the current day, of:
analysing the measurements of the gas consumption to produce predefined parameter measurements relating to gas consumption, and detecting, from said predefined parameter measurements, one or more operating phases of at least one predetermined system of the installation;
for each predetermined system, following each operating phase of said predetermined system, if a cumulated gas consumption during the current period of said predetermined system exceeds a predetermined threshold associated with said predetermined system, closing the valve until the end of said current period.

In addition, a monitoring method is proposed, such as described above, comprising the steps, for the current period, of:
detecting a start of a gas draw;
at the end of said gas draw, estimating an average gas flow during said gas draw;
detecting, from the average gas flow, an operating phase of one of the at least one predetermined system of the installation;
comparing the cumulated gas consumption during the current period of said predetermined system with the predetermined threshold associated with said predetermined system;
if the cumulated gas consumption of said predetermined system is greater than said predetermined threshold, verifying that a gas current consumption is zero and, if this is the case, closing the valve until the end of said current period.

In addition, a monitoring method is proposed, such as described above, comprising the preliminary step of verifying that the current period is not a period during which the closing of the valve is prohibited.

In addition, a computer program is proposed, comprising instructions which lead to the processing unit of the gas meter, such as described above, executing the steps of the monitoring method such as described above.

In addition, a recording medium which can be read by a computer is proposed, on which the computer program such as described above is recorded.

The invention will be best understood in the light of the description below of particular, non-limiting embodiments of the invention.

### BRIEF DESCRIPTION OF THE DRAWINGS

Reference will be made to the accompanying drawings, wherein:

FIG. 1 represents a gas meter according to a first embodiment;

FIG. 2 represents steps of a monitoring method;

FIG. 3 represents a gas meter according to a second embodiment.

### DETAILED DESCRIPTION OF THE INVENTION

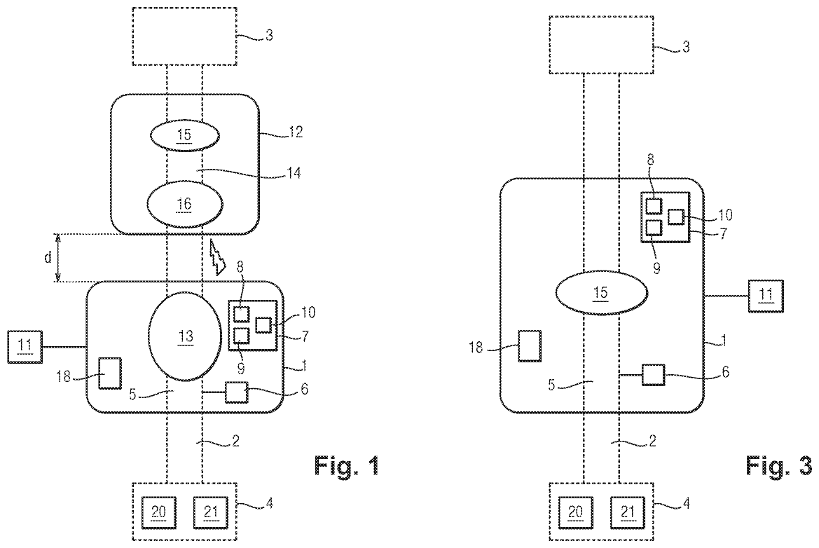

In reference to FIG. 1, the invention is, in this case, implemented in a gas meter 1.

The gas meter 1 is mounted on a main conduit 2 which makes it possible to connect a gas distribution network 3 to an installation 4.

The meter 1 integrates a first internal conduit 5 which extends into the continuity of the main conduit 2, such that the gas consumed by the installation 4 goes into the first internal conduit 5.

The meter 1 in addition integrates a measuring device 6, which is, in this case, an ultrasonic measuring device and which operates like the device described above.

The meter 1 in addition comprises a processing unit 7. The processing unit 7 comprises at least one processing component 8, which is, for example, a “general” processor, a processor specialising in the processing of the signal (or DSP, for Digital Signal Processor), a microcontroller, or a programmable logic circuit, such as an FPGA (for Field-Programmable Gate Array) or an ASIC (for Application-Specific Integrated Circuit). The processing unit 7 also comprises one or more memories 9, connected to or integrated in the processing component 8. At least one of these memories 9 forms a recording medium which can be read by a computer, on which at least one computer program is recorded, comprising instructions which lead the processing component 8 to execute at least some of the steps of the monitoring method which will be described below.

The processing unit 7 comprises a clock 10 of the RTC (for Real Time Clock) type, enabling it to integrate a calendar. A periodic resynchronisation of the clock 10 is done via a communication network. The clock 10 makes it possible to implement a timer.

The meter 1 is connected to a piece of equipment which integrates a temperature sensor 11. In this case, the equipment is positioned, such that the sensitive cell of the temperature sensor 11 is in contact with the air outside of the user's dwelling. The meter 1 receives the measurements produced by the sensor 11, which are therefore measurements of the temperature outside of the dwelling.

In an alternative embodiment, the equipment integrating the temperature sensor can be located outside and close to the meter, but inside the dwelling, so as to measure the ambient temperature around the meter.

In another embodiment, the temperature sensor could be located inside the meter.

The processing unit 7 acquires the measurements of the temperature produced by the temperature sensor 11.

The meter 1 in addition comprises first communication means which enable it to communicate with a cutoff box 12 located outside of the meter 1.

The distance d between the meter 1 and the cutoff box 12 is typically between 1 cm and 20 cm.

The first communication means comprise a first NFC (for Near Field Communication) interface 13. This is a “master” NFC interface.

The cutoff box 12 comprises a second internal conduit 14, a valve 15 and a second NFC interface 16 (“slave” NFC interface).

The second internal conduit 14 itself extends into the continuity of the main conduit 2 (and of the first internal conduit 5 of the meter 1).

The valve 15 is a motorised (electromechanical) valve. The valve 15 comprises a movable member which extends into the second internal conduit 14, and a current position of which can be controlled to cut off the gas flow. In this case, the valve 15 is a ball valve and the movable member is therefore a ball; the current position of the ball is an angular position.

The meter 1 and the cutoff box 12 communicate via the first NFC interface 13 and the second NFC interface 16. The meter 1 can thus operate the valve 15 to cut off the supply of gas to the installation.

Now, the monitoring method which is implemented in the processing unit 7 of the meter 1 is described.

The monitoring method aims to detect the use of a predetermined system of the installation 4 (among one or more predetermined systems), and to cut off the gas supplied to the installation 4 when the gas consumption by this system becomes too high.

The predetermined systems comprise, for example, a boiler, a water heater, a gas cooker, a gas fireplace, etc.

The monitoring method is, in this case, implemented at the user's initiative (but, it could be implemented systematically, or at the gas distributor's or the network manager's initiative).

Each current day is divided into a predetermined set of at least one successive period. In this case, each current day is divided into N successive periods Pk (k going from 1 to N). Each period Pk has, as a duration Hk and therefore has, for each current day:

$${\sum }_{k = 1}^{N} H k = 24 hours$$

The durations Hk and these periods Pk are not all necessarily identical.

The detection of a possible overconsumption is done by predetermined system, and period by period (and not daily, except for if the current day comprises one single period). Thus, each current day, for each current period, the cutting off of the gas is controlled when the cumulated consumption of one same predetermined system becomes too high over said current period.

The detection of the operating phases of these predetermined systems consists of detecting, in the measurements of the gas consumption, signatures, each representative of the use of a particular predetermined system.

Each signature corresponds to particular predefined parameter values relating to the gas consumption.

Thus, each current day, and for each current period, the processing unit 7 analyses the measurements of the gas consumption and produces predefined parameter measurements relating to the gas consumption.

By “measurement of the gas consumption”, this means any measurement representative of the gas consumption: index, flow measurement, volume measurement, etc.

The predefined parameters comprise, for example, a gas draw duration and/or an average gas flow and/or a volume of consumed gas.

The processing unit 7 thus detects, from predefined parameter measurements, operating phases of at least one predetermined system of the installation. By “operating phase”, this means a period during which the predetermined system operates and draws gas continuously.

Then, for each predetermined system, if the cumulated gas consumption of said predetermined system over the current period exceeds a predetermined threshold associated with said predetermined system, the processing unit 7 controls a closing of the valve 15 to cut off the gas supply to the installation 4 until the end of the current period.

The cutting off of the gas therefore consists of modifying the angular position of the ball of the valve 15 to close the valve 15.

It can be provided that, for at least one of the predetermined systems, the predetermined threshold associated with said predetermined system depends on the current period of the current day: it can thus be relevant to authorise a greater consumption in the morning (before leaving for work or school) and in the evening (on return).

It can also be provided that, for at least one of the predetermined systems, the predetermined threshold associated with said predetermined system depends on the current day: the authorised consumption can thus be greater at the weekend or during a public holiday.

It can also be provided that, for at least one of the predetermined systems, the predetermined threshold associated with said predetermined system depends on the period of the year to which the current day belongs: winter, the authorised consumption can thus be greater.

The predetermined threshold can also depend on several of these parameters, and therefore on the current period and/or on the current day and/or on the period of the year to which the current day belongs.

The predetermined system in question is, for example, a gas boiler, the gas consumption of which is greater in winter than in summer.

Likewise, for at least one of the predetermined systems (the boiler again, for example), the detection of the operating phases of said predetermined system can comprise the step of comparing the predefined parameter measurements with predefined levels which depend on the period of the year to which the current day belongs.

The processing unit 7 can also use the measurements of the temperature produced by the temperature sensor 11.

It is thus provided that, for at least one of the predetermined systems (the boiler again, for example), the predetermined threshold associated with said predetermined system depends on the temperature measured by the temperature sensor 11.

Likewise, it can be provided that, for at least one of the predetermined systems, the processing unit 7 is arranged, to detect the operating phases of said predetermined system, to compare the predefined parameter measurements with predefined levels which depend on the temperature measured by the temperature sensor 11.

It can also be provided that the predetermined periods comprise one or more periods, during which the closing of the valve 15 is prohibited, and therefore during which the gas cannot be cut off.

These periods comprise, for example, a period in the morning (before leaving for work, for school), and a period in the evening (on return).

The user can optionally themselves define these periods by communicating with the meter 1, which thus comprises communication means 18 adapted to this use.

These communication means 18 can be wireless radioelectric means (NFC, Wi-Fi, Bluetooth, etc.), even wired. This can also be an interface using, for example, one or more buttons and a screen positioned on the meter 1.

The water distributor (or the network manager) could also define these periods; in this case, the second communication means 18 are, for example, cellular communication means.

It is noted that the communication means 18 can be, more generally, used by the user and/or by the water distributor (or the network manager) to adjust the consumption thresholds, the number and the duration of the successive period in the current days, etc.

A particular embodiment is interesting, wherein the predetermined systems of an installation comprise a gas boiler 20 and a water heater 21.

The type of gas consumption (boiler 20 or water heater 21) is recognised by a signature which is itself defined by the following predefined parameters: gas draw duration, average gas flow and the volume of gas consumed.

The average gas flow thus typically belongs to a different flow range (in L/minute) when the gas is drawn, according to which the system which draws the gas is a boiler or a water heater. Likewise, the gas draw duration is typically less than a different time threshold, and the volume of gas consumed is typically less than a different volume threshold, according to which the system which draws the gas is a boiler or a water heater.

A boiler is intended to consume around 1000 m3/year and draw gas periodically (for 10 minutes each time, for example), over a cumulated duration of 8 hours a day from October to March inclusive, and of 2 hours a day from April to September inclusive.

The cumulated consumption from October to March inclusive is around 800 m3 and, between October and March, there is:
Average flow: D=9.16 L/minute;
Draw duration: t=10 minutes;
Reference daily consumption volume threshold: S=4395 L.

The cumulated consumption from April to September inclusive is around 200 m3 and, between April and September, there is:
Average flow: D=9.11 L/minute;
Draw duration: t=10 minutes;
Reference daily consumption volume threshold: S=1093 L.

A water heater is intended to consume around 300 m3/year and to draw gas “on demand” in order to produce hot water (case of a shower, a bath, bathroom sink, kitchen sink). The cumulated duration of the gas draw is around 1 hour a day. There is:
Average flow: D=13.70 L/minute;
Draw duration: variable t (a few seconds (bathroom, kitchen sink) to 5 minutes (shower) even 15 minutes (bath));
Reference daily consumption volume threshold: S=822 L.

The volume threshold therefore does not depend on the period of the year for the water heater.

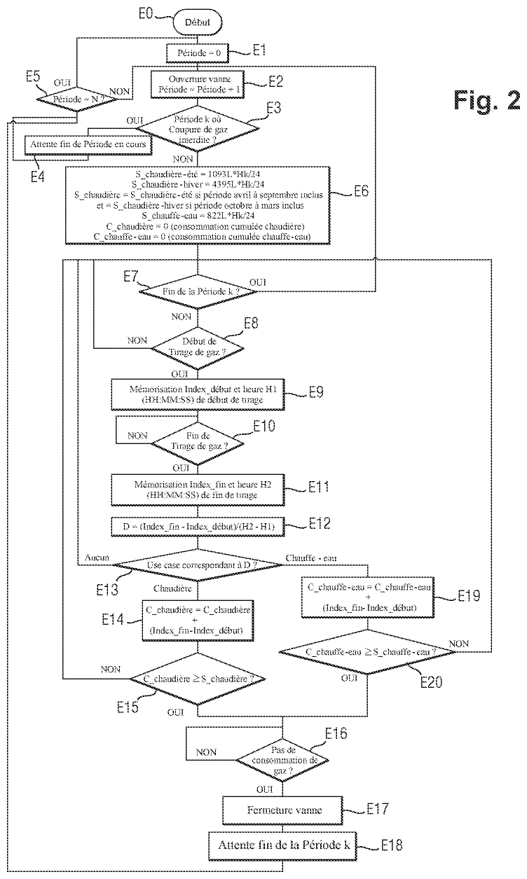

Now, in reference to FIG. 2, an example of an implementation of the monitoring method is described more specifically.

The N successive periods Pk, and the durations Hk of said periods, are preprogrammed in a table stored in one of the memories 9 of the processing unit 7.

As it has been seen, the successive periods possibly comprise one or more periods, during which the closing of the valve 15 is prohibited.

The method starts at step E0, for the current day.

The “Period” variable is initialised to 0 (step E1).

The processing unit 7 thus opens the valve 15, and increments the Period variable:
Period=Period+1 (step E2).

The processing unit 7 verifies if the current period Pk is a period wherein the closing of the valve 15 is prohibited (step E3).

If this is the case, the processing unit 7 awaits the end of the current period Pk (step E4), then verifies if the current period Pk is the last of the current day (i.e. if Period=N): step E5.

If this is the case, the method goes to step E1. Otherwise, the method goes back to step E2.

In step E3, if the current period Pk is not a period, wherein the closing of the valve 15 is prohibited, the method goes to step E6.

The following variables are initialised by the processing unit 7:
Threshold_boiler-summer=1093 L*Hk/24;
Threshold_boiler-winter=4395 L*Hk/24;
Threshold_boiler=Threshold_boiler-summer if the current day belongs to a period going from April to September inclusive, and Threshold_boiler=Threshold_boiler-winter if the current day belongs to a period going from October to March inclusive;
S_water-heater=822 L*Hk/24;
C_boiler=0.

Thus, for each period, and for each predetermined system, the predetermined consumption threshold is defined pro rata of the duration of said period applied to the corresponding daily reference threshold.

The processing unit 7 thus verifies if the present time corresponds to the end of the current period (step E7). If this is the case, the method goes back to step E2.

Otherwise, the processing unit 7 attempts to detect the start of a gas draw (i.e. that a system of the installation starts to consume gas): step E8.

It is considered that a gas draw has started if the gas consumption is greater than or equal to a predefined threshold (for example, 1 L) for a predefined duration (for example, 10 s).

As long as the start of a gas draw is not detected, the method goes back to step E7 (then again in step E8, if this is not at the end of the current period).

When the start of a gas draw is detected, the processing unit 7 memorises the index at the start of the draw (Index_start) and the time H1 of the start of the draw (HH:MM:SS): step E9.

The Index_start variable is the consumption index measured at the present time by the measuring device 6—i.e. the cumulated gas volume measured at the present time.

Then, the processing unit 7 verifies if the gas draw is ended (step E10). As long as the gas draw is not ended, the method loops over step E10.

When the gas draw is ended, the processing unit 7 memorises the index at the end of the draw (Index_end) and the time H2 of the end of the draw (HH:MM:SS): step E11.

At the end of the gas draw, the processing unit 7 estimates a duration of the gas draw (equal to H2−H1) and an average gas flow during said gas draw (step E12).

In this case, the processing unit 7 evaluates the average gas flow by using the formula:
D=(Index_end−Index_start)/(H2−H1).

The processing unit 7 thus attempts to detect from the average gas flow, an operating phase of one of the at least one predetermined system (step E13).

For this, the processing unit 7 compares the average gas flow with predefined levels.

If the average gas flow D is such that:
8 L/minute≤D≤10 L/minute,
thus the processing unit 7 detects an operating phase of the boiler 20.

If the average gas flow D is such that:
13 L/minute≤D≤15 L/minute,
thus the processing unit 7 detects an operating phase of the water heater 21.

If no predetermined system corresponds, the method goes to step E7.

If the detected predetermined system is the boiler 20, the processing unit 7 calculates the cumulated gas consumption of the boiler over the current period (step E14):
C_boiler=C_boiler+(Index_end−Index_start)

The processing unit 7 thus compares the cumulated gas consumption of the boiler 20 over the current period Pk with the predetermined threshold associated with the boiler 20 (step E15).

The processing unit verifies if:
C_boiler≥S_boiler.

If this is not the case, the method goes back to step E7.

If this is the case, i.e. if the cumulated consumption of the boiler 20 over the current period is greater (in this case, greater than or equal to) the predetermined threshold, the processing unit 7 verifies by safety, that the gas current consumption is zero (step E16).

As long as the gas current consumption is not zero, the method loops over step E16.

When the gas current consumption becomes zero, the processing unit 7 controls the closing of the valve 15 (step E17).

The processing unit 7 thus awaits the end of the current period (step E18), such that the valve 15 remains closed until the end of said current period, then the method goes back to step E5.

Likewise, in step E13, if the detected predetermined system is the water heater 21, the processing unit 7 calculates the cumulated consumption of the water heater 21 (step E19):
C_water-heater=C_water-heater+(Index_end−Index_start)

The processing unit 7 thus compares the cumulated consumption of the water heater 21 over the current period Pk with the predetermined threshold associated with the water heater (step E20).

The processing unit 7 verifies if:
C_water-heater≥S_water-heater.

If this is not the case, the method goes back to step E7.

If this is the case, i.e. if the cumulated gas consumption of the water heater 21 over the current period is greater (in this case, greater than or equal to) than the predetermined threshold, the processing unit 7 goes to step E16.

Alternatively, as temperature measurements are available, it can be provided that the predetermined threshold associated with one (or more) of the predetermined systems depends on the temperature measured by the temperature sensor 11.

The predetermined threshold can thus be adapted for the boiler 20 according to the temperature (in ° C.) measured by the temperature sensor 11. The calendar period is thus no longer considered.

The predetermined threshold for the boiler 20 is, for example:
equal to the first value when said temperature is less than a first temperature threshold;
equal to a second value when said temperature is greater than a second temperature threshold;
equal to a linear function of said temperature when said temperature is comprised between the first temperature threshold and the second temperature threshold.

In this case, the first temperature threshold is equal to 0° C., the second temperature threshold is equal to 20° C., and there is, for the period Pk of duration Hk hours (S is the predetermined threshold, T the temperature measured by the sensor 11):
if T<0° C., S=4395*Hk/24
if T>20° C., S=1093*Hk/24
If 0° C.≤T≤20° C.:
S=(1093+(4395−1093)*(20−T)/20)*Hk/24

In a second embodiment, in reference to FIG. 3, the valve 15 is not this time located in a cutoff box outside of the meter 1, but is integrated in the meter 1. The monitoring method is implemented in the same way if this is not that, in this configuration, the meter 1 does not need to communicate with a piece of external equipment: the processing unit 7 directly operates the valve 15.

Naturally, the invention is not limited to the embodiments described, but includes any variant entering into the field of the invention such as defined by the claims.

The signatures of the predetermined systems are not necessarily defines by the gas draw duration, the average gas flow and the volume of gas consumed, but can be defined by only one or two of these predefined parameters.

The predefined parameters can moreover be different from those described in this case, and could, for example, comprise a consumption gradient or a current flow (and not average).

The predetermined systems of the installation, the consumption of which is monitored, can comprise one or more different systems, and for example, a gas cooker, a gas fireplace, etc.

1. A gas meter comprising:
a measuring device arranged to produce measurements of a gas consumption of an installation;
a valve, or means for communicating with a cutoff box located outside of the meter and integrating a valve;
a processing unit arranged for, each current day, during each current period of a predetermined set of at least one successive period defined in the current day:
analysing the measurements of the gas consumption to produce predefined parameter measurements relating to the gas consumption, and detecting, from said predefined parameter measurements, one or more operating phases of at least one predetermined system of the installation;
for each predetermined system, following each operating phase of said predetermined system, if a cumulated gas consumption during the current period of said predetermined system exceeds a predetermined threshold associated with said predetermined system, closing the valve until the end of said current period.

2. The gas meter according to claim 1, wherein the predefined parameters comprise a gas draw duration and/or an average gas flow and/or a volume of gas consumed.

3. The gas meter according to claim 1, wherein, for at least one of the at least one predetermined system, the predetermined threshold associated with said predetermined system depends on said current period and/or on the current day and/or on the period of the year to which the current day belongs.

4. The gas meter according to claim 1, comprising a temperature sensor or being connected to a piece of equipment integrating a temperature sensor, the gas meter being such that, for at least one of the at least one predetermined system, the predetermined threshold associated with said predetermined system depends on a temperature measured by the temperature sensor.

5. The gas meter according to claim 4, wherein said predetermined threshold is:
equal to the first value when said temperature is less than a first threshold;
equal to a second value when said temperature is greater than a second threshold;
equal to a linear function of said temperature when said temperature is comprised between the first threshold and the second threshold.

6. The gas meter according to claim 1, wherein, for at least one of the at least one predetermined system, the processing unit is arranged, to detect the operating phases of said predetermined system, to compare the predefined parameter measurements with predefined levels which depend on the period of the year to which the current day belongs.

7. The gas meter according to claim 1, the gas meter comprising a temperature sensor or being connected to a piece of equipment integrating a temperature sensor, the gas meter being such that, for at least one of the at least one predetermined system, the processing unit is arranged, to detect the operating phases of said predetermined system, to compare the predefined parameter measurements with predefined levels which depend on a temperature measured by the temperature sensor.

8. The gas meter according to claim 1, wherein the predetermined set of at least one successive period comprises at least one period during which the closing of the valve is prohibited.

9. The gas meter according to claim 1, wherein the at least one predetermined system comprises a boiler and a water heater.

10. The gas meter according to claim 1, wherein the valve is a ball valve.

11. A monitoring method, implemented in the processing unit of a gas meter according to claim 1, and comprising the steps, each current day, during each current period of a predetermined set of at least one successive period defined in the current day, of:
analysing the measurements of the gas consumption to produce predefined parameter measurements relating to the gas consumption, and detecting, from said predefined parameter measurements, one or more operating phases of at least one predetermined system of the installation;
for each predetermined system, following each operating phase of said predetermined system, if a cumulated gas consumption during the current period of said predetermined system exceeds a predetermined threshold associated with said predetermined system, closing the valve until the end of said current period.

12. The monitoring method according to claim 11, comprising the steps, for the current period, of:
detecting a start of a gas draw;
at the end of said gas draw, estimating an average gas flow during said gas draw;
detecting, from the average gas flow, an operating phase of one of the at least one predetermined system of the installation;
comparing the cumulated gas consumption during the current period of said predetermined system with the predetermined threshold associated with said predetermined system;
if the cumulated gas consumption of said predetermined system is greater than said predetermined threshold, verifying that a current gas consumption is zero and, if this is the case, closing the valve until the end of said current period.

13. The monitoring method according to claim 12, comprising the preliminary step of verifying that the current period is not a period during which the closing of the valve is prohibited.

14. (canceled)

15. A non-transitory recording medium which can be read by a computer, on which a computer program is recorded, wherein the computer program comprises instructions which lead to a processing unit of the gas meter according to claim 1, executing a monitoring method, implemented in the processing unit of the gas meter, and comprising the steps, each current day, during each current period of a predetermined set of at least one successive period defined in the current day, of:
analysing the measurements of the gas consumption to produce predefined parameter measurements relating to the gas consumption, and detecting, from said predefined parameter measurements, one or more operating phases of at least one predetermined system of the installation;
for each predetermined system, following each operating phase of said predetermined system, if a cumulated gas consumption during the current period of said predetermined system exceeds a predetermined threshold associated with said predetermined system, closing the valve until the end of said current period monitoring method.
